(19) United States
(12) Patent Application Publication
(10) Pub. No.: US 2019/0111558 A1
(43) Pub. Date: Apr. 18, 2019

(54) Combination Tool Attachment System

(71) Applicant: Ty-Flot, Inc., Manchester, NH (US)

(72) Inventors: Darrell A. Moreau, Manchester, NH (US); Andre W. Moreau, Bedford, NH (US)

(21) Appl. No.: 15/783,083

(22) Filed: Oct. 13, 2017

(51) Int. Cl. B25G 1/10; B25B 13/04; B25B 13/08; B25B 23/16; B66F 15/00; B66F 17/00

(52) U.S. Cl. CPC B25G 1/102; B25B 13/04; B25B 13/08; F16B 45/00; B66F 15/00; B66F 17/00; B25B 23/16

(57) ABSTRACT

A combination tool attachment system for combination hand tools and other dual working end tools, having a small body shaft, e.g., a combination wrench, or having a large body shaft, e.g., a combination crowbar. More specifically the present invention provides a combination tool attachment system which enables secure fastening of the combination tool to a lanyard fastener via a connector ring. The combination tool has margin portions along the body shaft to prevent the connector ring from interfering with either working end of the combination tool.

### BACKGROUND OF THE INVENTION

### 1. Field of the Invention

The present invention relates generally to hand tools and accessories. More particularly, the present invention relates to a combination tool attachment system for combination hand tools and other dual working end tools.

### 2. Description of the Prior Art

Hand tools are widely used in construction, maintenance, and industrial facilities operations. The user of a tool often stores tools in a bag, box, pouch, or tool belt when the tool is not being used. The user then selects the appropriate tool for a given task and returns the tool to its storage location after the task is complete. For tasks performed at elevated heights, dropping a tool can cause injury to individuals or damage to objects below the worker. The dropped tool also is a significant inconvenience for workers who must spend time to retrieve the dropped tool.

Tool makers have partially addressed the problem of dropped tools by attaching a ring or grommet to the tool by forming a sleeve over the end of the tool's handle or grip where the sleeve has a solid end with an opening in the solid end. For example, one line of tools includes hammers, hinged pliers, and adjustable spanners that have a rubber sleeve formed over the grip of the tool with a solid end portion of the sleeve extending beyond the end of the grip. A ring passes through an opening or grommet in the solid end of the rubber sleeve. The user clips one end of a lanyard to the ring and attaches the other end of the lanyard to the user's tool belt, scaffolding, ladder, or other object.

Another method of addressing the problem of dropped tools is a lanyard attachment assembly that includes a ring attached to a leader. The leader is a generally-flat strip of material that is secured to a tool by heat shrink tubing slipped over both the tool and the leader. The heat shrink tubing is subsequently heated, thereby shrinking the tubing to provide a snug fit over the leader and securing the leader to the tool.

### SUMMARY OF THE INVENTION

One limitation of currently-available tool attachment methods is that some methods rely on the tool having an unused or free end of the handle to which a rubber sleeve or ring may be attached. This design is not useful, however, for two-ended tools with functional features on each end of the tool. A combination wrench, for example, has one open end and one box end to provide dual functionality. Attaching a ring by using a sleeve formed over either end of the combination wrench renders that end of the wrench useless for its intended use. Similarly, connecting a ring through the box-end of a wrench renders that end useless for turning bolts because the ring is in the way of the bolt head.

One limitation of attachment assemblies that include a leader secured to the tool with heat shrink tubing is that this design has proven unreliable. The assembly fails because the leader may be inadvertently pulled out from the heat shrink tubing. Therefore, what is needed is an improved combination tool connector system for hand tools and other objects.

It is an object of the present invention to provide a combination tool connector system that reinforces safety. It is also an object of the present invention to provide a combination tool connector system that increases productivity. It is also an object of the present invention to provide a combination tool connector system that reduces operating costs. It is also an object of the present invention to provide a combination tool connector system that has improved reliability over known lanyard attachment assemblies.

The present invention achieves these and other objectives by providing a combination wrench, pincher bar, lever bar, or other hand tool having a connector fixedly attached to the tool and movable along the length of the handle/body shaft. A longitudinal channel extending along the length of the handle has an inner wall surface of decreased surface friction compared to an outer surface friction. By providing this channel along a portion of the handle, shorter than the entire length of the tool, the connector may travel freely along the handle portion without interfering with either working end of the tool. This connector may then be employed to connect to various safety or security straps.

The present invention also achieves these objectives by providing a combination tool connector system, having a combination wrench, an adaptor in the form of a channel along a portion of the handle of the wrench defined by first and second margin portions, and a closed connector passing through the channel.

The present invention provides a combination tool attachment system which has a combination tool which has opposed first and second working ends having opposed first and second neck portions, respectively. A body shaft extends between the first and second neck portions, the body shaft has first and second margin portions and a middle portion therebetween. The first and second margin portions are near the first and second neck portions, respectively. At least one adaptor channel extends lengthwise along the body shaft between the first and second margin portions. A ring connector has an adaptor interface which interacts with the at least one adaptor channel. A coupling interface is capable of interacting with a carabiner, by at least partially defining an incircle with a diameter of a size sufficient to interconnect with a lanyard fastener. First and second margin portion lengths of the body shaft are both greater than a length of the ring connector, to prevent the ring connector from interfering with either working end.

### BRIEF DESCRIPTION OF THE DRAWINGS

FIG. 1 is front perspective view of a ring connector attaching a carabiner with a combination wrench via an adaptor channel extending through the height of the wrench.

FIG. 2 is a front-vertical cross-sectional view showing various dimensions of the embodiment shown in FIG. 1.

FIG. 3 shows moving directions along a right sideview of the embodiment shown in FIG. 1.

FIG. 4 shows various dimensions and moving directions along a top view of the embodiment shown in FIG. 1.

FIG. 5 is a front perspective view of an extending adaptor interface of a connector attaching a carabiner with a combination wrench via an adaptor channel extending through the height of the wrench.

FIG. 6 is a right sideview of the embodiment shown in FIG. 5.

FIG. 7 is bottom view of the embodiment shown in FIG. 5.

FIG. 8 is a back rearview of the embodiment shown in FIG. 5.

FIG. 9 is a cross-sectional view of the embodiment shown in FIG. 5.

FIG. 10 is a front perspective view of a combination wrench with a modified ring connector having an extending adaptor interface extending through the height of the wrench via an adaptor channel.

FIG. 11 is a front view of the embodiment shown in FIG. 10.

FIG. 12 is cross-sectional view of the embodiment shown in FIG. 10.

FIG. 13 is a bottom view of the embodiment shown in FIG. 10.

FIG. 14 is a right sideview of the embodiment shown in FIG. 10.

FIG. 15 is a front-right-side perspective view of a releasable interlocking connector and corresponding combination wrench with at least one side channel.

FIG. 16 is a front-left-side perspective view of the embodiment shown in FIG. 15.

FIG. 17 is a right-side view of the embodiment shown in FIG. 15.

FIG. 18 is a front view of the embodiment shown in FIG. 15.

FIG. 19 is a cross-sectional view of the embodiment shown in FIG. 15.

FIG. 20 is a bottom-right-side perspective view of a ring connector attaching a carabiner with a combination pincher bar via an adaptor channel extending through the height of the pincher bar.

FIG. 21 is a horizontal cross-sectional side view of the embodiment shown in FIG. 20.

FIG. 22 is a frontal view of the embodiment shown in FIG. 20.

FIG. 23 is a vertical cross-sectional frontal view of the embodiment shown in FIG. 20.

FIG. 24 is a front perspective view of a combination pincher bar and a half-ring connector with a straight adaptor interface extending through an adaptor channel extending completely through the pincher bar.

FIG. 25 is a top view of the embodiment in FIG. 24.

FIG. 26 is a front view of the embodiment in FIG. 24.

FIG. 27 is a frontal cross-sectional view of the embodiment in FIG. 24.

FIG. 28 is a front perspective view of a combination pincher bar and a folding connector with a branching adaptor interface extending partially through the pincher bar.

FIG. 28A is a top view of the embodiment in FIG. 28.

FIG. 29 is an enlarged partial cross-sectional side-view of the embodiment in FIG. 28.

FIG. 30 is a frontal cross-sectional view of the embodiment in FIG. 28.

FIG. 31 is a back view of the embodiment in FIG. 28.

FIG. 32 is a front perspective view of a combination pincher bar with dual branching adaptor channels extending partly through the height of the pincher bar, and a connector having complimentary dual adaptor interfaces.

FIG. 33 is a top view of the embodiment in FIG. 32.

FIG. 34 is a frontal view of the embodiment in FIG. 32.

FIG. 35 is a cross-sectional view of the embodiment in FIG. 32.

FIG. 36 is a perspective view of a releasable interlocking connector and corresponding combination pincher bar with at least one transverse side channel.

FIG. 37 is a top view of the embodiment in FIG. 36.

FIG. 38 is a frontal view of the embodiment in FIG. 36.

FIG. 39 is a cross-sectional view of the embodiment in FIG. 36 illustrating the transverse directionality of the adaptor channel and interlocking connector in relationship to at least one working end.

FIG. 40 is a perspective view of a releasable interlocking connector and corresponding combination pincher bar with at least one transverse side channel.

FIG. 41 is a top view of the embodiment in FIG. 40.

FIG. 42 is a first frontal partially-exploded view, illustrating the interlocking ring connector in disconnected form, of the embodiment in FIG. 40.

FIG. 43 is a second frontal partially exploded view, illustrating the insertion of channel seal after the interlocking ring connector is connected, of the embodiment in FIG. 40.

### DETAILED DESCRIPTION OF THE PRESENT INVENTION

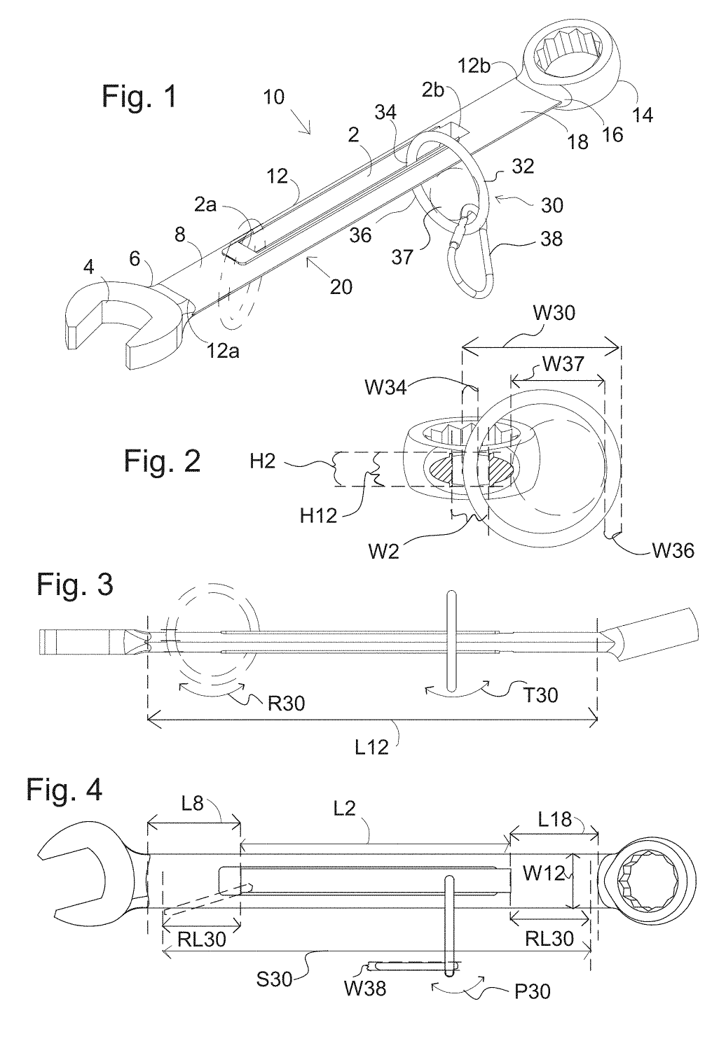

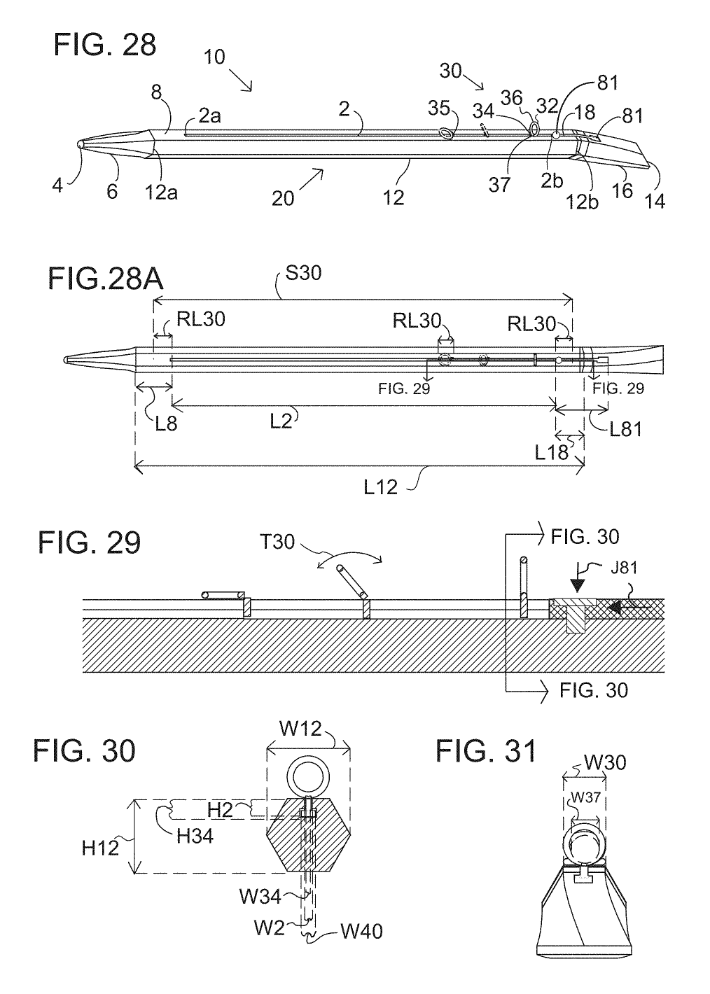

The preferred embodiments of the present invention are illustrated in FIGS. 1-43. Features which are universal to the present invention, regardless of embodiment, will now be discussed generally. Structural features are indicated via reference numbers, i.e., system ‘10’, tool ‘20’, etc. Various dimensions and directional movements of relevant features are referenced alphanumerically, i.e., ‘W’ for width (or diameter), “L” for length, ‘H’ for height, ‘S’ sliding direction, ‘R’ for rotational direction, ‘T’ for tilting direction, and ‘P’ for pivotal direction.

Combination Tool with Adaptor Channel

The present invention is a combination tool attachment system 10 having a combination tool 20 with at least one elongated adaptor channel 2 along a middle portion 12a of a body shaft 12 of the tool 20. A ring connector 30 is attached to the body shaft 12 of the combination tool 20 via the at least one adaptor channel 2.

Combination tools 20 are defined as those tools having a first working end 4 and a second working end 14, generally opposite one another. Each of the first and second working ends 4, 14 have a neck portion 6, 16 capable of commuting directional force applied along the body shaft 12 to the associated working end 4, 14. The body shaft 12 extends between the first and second neck portions 6, 16 of the first and second working ends 4, 14.

Each tool 20 also has a first and a second margin portion 8, 18 of the body shaft 12 adjacent the respective first and second working ends 4, 14. The at least one elongated channel 2 extends from a first channel end 2a spaced from the first neck portion 6 by the first margin portion 8 along the body shaft 12 to a second channel end 2b spaced from the second neck portion 16 by the second margin portion 18. The first margin portion 8 is the portion of the body shaft 12 between the first channel end 2a and the first neck portion 6. The second margin portion 18 is the portion of the body shaft 12 between the second channel end 2b and the second neck portion 16.

The first and second margin portions 8, 18 of the body shaft 12 each have a length L8, L18 which is greater than a reaching length RL30 of the ring connector 30. Regardless of the shape of the ring connector 30 employed, the furthest edge(s) 32 of the ring connector 30 is prevented from ever interfering with either the first or second working ends 4, 14 of the tool 20. For example, when using the first or the second working ends 4, 14, a user grabs the body shaft 12 respectively, and the ring connector 30 slides to either first or second channel ends 2a, 2b. The length of the first and second margin portions 8, 18 of the body shaft 12 prevent the ring connector 30 from extending to an interference position adjacent either working end 4, 14 of the tool 20.

Or otherwise stated, the first margin portion 8 of the body shaft 12 extends between the first channel end 2a of the adaptor channel 2 and the first working end 4. The first margin portion 8 has a non-interference length L8 that is at least the longest reaching length RL30 of the ring connector 30. This first length L8 ensures that when the ring connector 30 is adjacent the first working end 4, every portion of the ring connector 30, including the furthest extending edge 32, is prevented from interfering with the first working end 4.

Opposite this, a second margin portion 18 of the body shaft 12 extends between the second channel end 2b of the adaptor channel 2 and the second working end 14. The second margin portion 18 has a second non-interference length L18 that is also at least the longest reaching length RL30 of the ring connector 30. This second non-interference length L18 ensures that when the ring connector 30 is adjacent the second working end 14, every portion of the ring connector 30 is prevented from interfering with the second working end 14.

Ring Connector with Adaptor & Coupling Interfaces

The ring connector 30 has one main function—to connect the combination tool 20 with a lanyard fastener 38 such as, for example, a carabiner, loops of additional external safety harnesses, and other similar structures (not shown). To achieve this function, the ring connector 30 must have an adaptor interface 34 capable of interacting with the adaptor channel 2 of the combination tool 20, and a coupling interface 36 capable of interacting with the lanyard fastener 38.

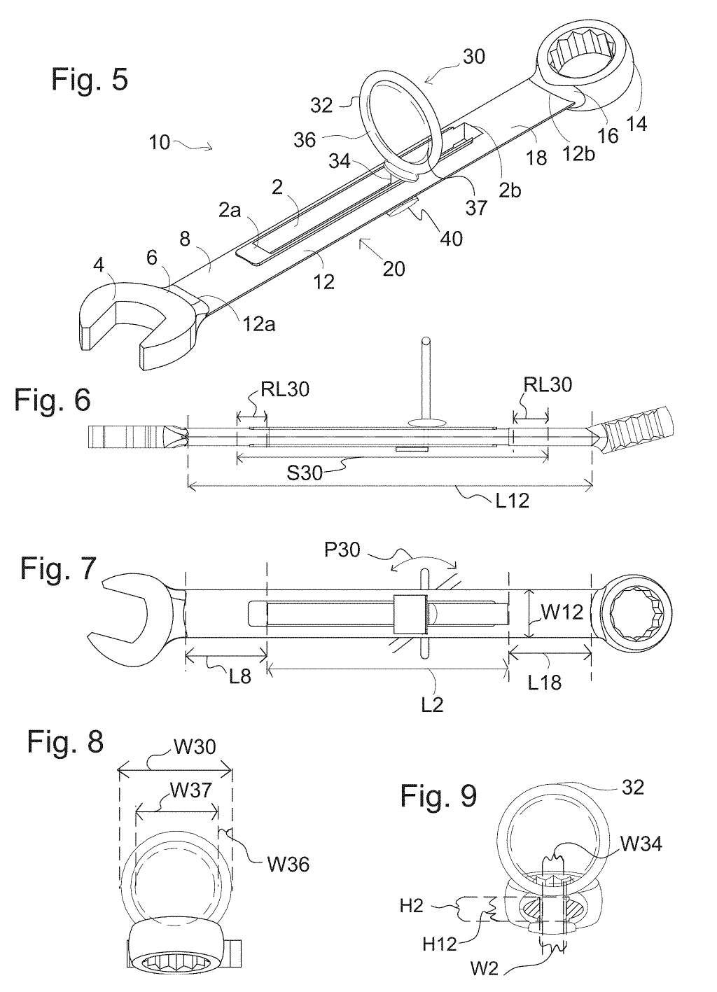

In order to securely capture and couple the lanyard fastener 38, the coupling interface 36 must have an enclosed space which is unencumbered by the body shaft 12 and displaced from the combination tool 20 itself. This enclosed space, defining a coupling aperture incircle 37, is formed by the coupling interface 36 (FIGS. 5-9), or the interaction of the coupling interface 36 with the combination tool 20, (FIGS. 1-4). Incircle means the largest circle that will fit inside another circle or polygonal shape and touch each side in just one place so each of the sides is a tangent to the incircle. The coupling incircle 37 is the largest unencumbered circle that fits inside the coupling interface 36 or between surfaces of the coupling interface 36 and surfaces of the combination tool 20. Preferably the incircle 37 of the coupling interface 36 has an incircle diameter W37 of between 2 mm and 28 mm, and more preferably, about 4 mm, to facilitate connection with the lanyard fastener 38.

The term ring connector referred to in this specification means both ring connectors and modified ring connectors where modified ring connectors include D-clasps, D-rings, shackles; carabiners; snap hooks; modified eye bolts; and other similar shapes. Ring connectors of the present invention may be manufactured (a) integrally, (b) as separate distinct components which are then irreversibly connected (welded), or (c) as distinct components which may be reversibly interlocked with one another.

Examples of shackles include bow/anchor shackles; chain/dee shackles, headboard shackles, snap shackles, twist shackles, and the like. Anchor shackles, (not shown) refer to a shackle with a larger, rounded “O” shape look—providing a larger incircle diameter of the coupling interface. Bow shackles (not shown) typically have a larger and more defined bow area than an anchor shackle. Bow shackles have a body diameter that is equal to the pin diameter. The rounded design and larger loop shape of an anchor shackle or bow shackle reduce its overall strength, but also allow them to take loads from many directions without developing significant side load or torsional stress.

Chain Shackles, also known as D-shackles, and headboard shackles, (not shown) are narrower than a bow or anchor shackle. Generally, chain shackles have a threaded pin or other pin to close the space. Having a smaller loop, these types of shackles are generally designed to take high loads in line. As side and racking loads may twist or bend this shackle, these types of shackles are not preferred for embodiments in which rotation, tilting, or pivoting is permissible.

Snap shackles are designed with a spring-activated mechanism to use quickly and with one hand (not shown). This is preferred for jobs where speed is important, or when it needs to be repeatedly connected and disconnected. However, these shackles have lower working load limits (WLL) compared to other shackles and hence are not recommended for heavy-duty combination tools, i.e., weighs over 5 lbs.

A twist shackle (not shown) is usually somewhat longer than other shackles. A nice feature of this shackle is a 90° twist within the length of the body, so an axis of the incircle of the coupling interface is parallel to the axis of the pin. That is, the furthest reaching edge is perpendicular to the pin.

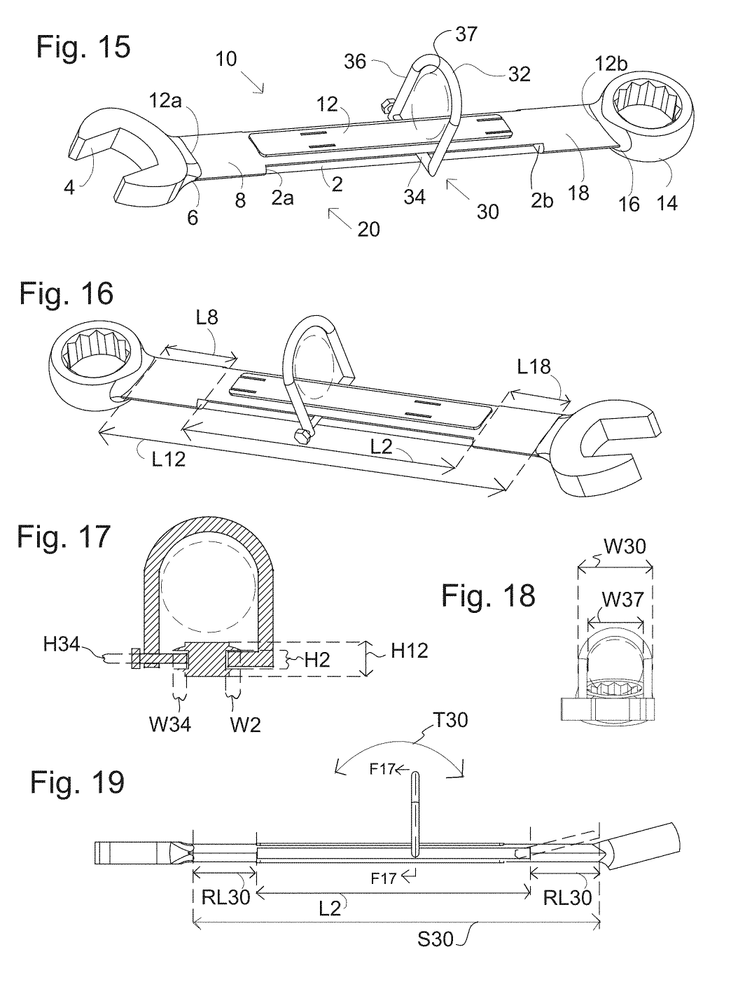

As evidenced above, the connector ring 30 of a particular embodiment 10 may have unique shapes and/or overall lengths L30. Additionally, depending upon the possible degree of rotation R30 (FIG. 1-4), pivoting P30 (FIG. 5-14), and tilting T30 (FIG. 15-19, 28-31), a single connector ring 30 may also have various configurations and/or orientations. To cover each possible configuration and/or orientation for each embodiment, the reaching length RL30 is defined as the greatest length ‘reachable’ by any furthest reaching edge 32 of a single connector ring 30 regardless of any possible rotation R30 (FIG. 1-4), pivot P30 (FIG. 5-14), and/or tilt T30 (FIG. 15-19, 28-31) of the connector ring 30 with respect to the adaptor channel 2 and body shaft 12.

Reaching lengths, reaching edges, and other specific features of the present invention will now be discussed in greater detail below with reference to various embodiments and their associated drawings.

FIG. 1-4 Wrench Having Torus Ring Connector

Specifically, FIGS. 1-4 illustrate various views of the combination tool attachment system 10 according to the present invention. The combination tool attachment system 10 includes a combination tool 20 having a body shaft 12, an adaptor channel 2 formed within a middle portion of body shaft 12. A ring connector 30 is slidably attached within adaptor channel 2. The combination tool 20 illustrated here is a combination wrench 20 having a first working end 4 with a fixed open jaw. The first working end 4 is opposite a second working end 14 with a box end in a plane shifted from the plane of the body shaft 12 by approximately 15 degrees. In combination wrench 20, each of the first and second working ends 4, 14 have a neck portion 6, 16 capable of commuting force applied along the shaft 12 to the associated working end 4, 14. The body shaft 12 extends between the first and second working ends 4, 14.

In this embodiment, the adaptor channel 2 is a through-channel having a channel height H2 that is equal to the body shaft height H12, a channel width W2 that is less than the body shaft width W12, and a channel length L2 that is less than a body shaft length L12. Specifically, the channel length L2 is less than a body shaft length L12 by more than twice the connector reaching length RL30 due to first and second margin portions 8, 18. The first and the second margin portion non-interference lengths L8, L18 may be incongruent, i.e., L8≠L18; or equivalent, i.e., L8=L18. As shown here, the first margin portion non-interference length L8 is greater than the second margin portion non-interference length L18, i.e., L8>L18.

Regardless, both the first and the second margin portion non-interference lengths L8, L18 must be greater than the reaching length RL30 of the ring connector 30, i.e., L8>RL30, L18>RL30. Thus, despite any moving of the ring connector 30, e.g., rotating R30, pivoting P30, tilting T30, and sliding S30, with respect to the body shaft, the furthest edge 32 of ring connector 30 is always prevented from interfering with either the first or second working ends 4, 14 of tool 20. Thus, whether a user grabs the body shaft 12 on either side of ring connector 30 when using either the first or the second working ends 4, 14, the first and second margin portions 8, 18 of the body shaft 12 prevent the ring connector 30 from extending to an interference position adjacent either working end 4, 14 of the tool 20.

The ring connector 30 illustrated in FIGS. 1-4 is permanently affixed to the wrench 20 and has a shape of a solid ring torus having a diameter (width) W30 of approximately 2 inches. As a torus, adaptor interface 34 is not a single separable component of ring connector 30, but may still be defined by a ratio of characteristics, i.e., a cross-sectional adaptor interface aspect C30, corresponding to the constant continual cross-sectional diameter of the body of the ring connector 30, which is less than an adaptor width W2 of adaptor channel 2. This ratio of characteristics relating the cross-sectional diameter C30 and the adaptor width W2, i.e., C30<W2, facilitates movement along a rotational direction R30, pivoting direction P30, tilting direction T30, and sliding direction S30.

If one of the edges of the tool 20 defines an interior edge of the connection interface 36, then the space between the outer surface of the tool 20 and the inner surface of the ring connector 30 may have a non-uniform shape, which could cause difficulties when attaching an element having a uniform shape, e.g., a carabiner 38. For this reason, in this application, the connection interface 36 is defined by a portion of space within the ring connector 30, adjacent yet displaced from the body shaft 12, specifically, that internal utilizable space defined as having incircle diameter W37.

Thus, in this embodiment, the coupling interface 36 is not a separable, single component of the ring connector 30, but may also be defined by a ratio of characteristics, i.e., the connector diameter W30 being greater than the body width W12 less the adaptor channel width W2 plus the carabiner cross-sectional diameter W38, e.g., W30>(W12−W2+W38). Or otherwise stated, the incircle diameter W37 is greater than the carabiner cross-sectional diameter W38, e.g., W37>W38. Preferably, the incircle diameter W37 is greater than 2 mm for various sized carabiners 38. These ratios of characteristics facilitate rotating R30, pivoting P30, tilting T30, and sliding S30—without resulting in possible interference of the ring connector 30 about either working end 4, 14.

FIG. 5-9 Extending Adaptor Interface

The combination tool attachment system 10 according to the present invention shown next in FIGS. 5-9 illustrate various views of a combination wrench 20 having an adaptor channel 2 by which a ring connector 30 is attached along a portion of the length of the body shaft 12. As this embodiment is identical in most respects to the embodiment shown in FIGS. 1-4, only those features which are unique to this embodiment will now be discussed.

Specifically, the ring connector 30 has an extending adaptor interface 34 which extends downwardly and outwardly from the coupling interface 36. By extending the adaptor interface 34 outwardly from the coupling interface 36, the ring connector 30 illustrated in FIGS. 5-9 need not be affixed to the wrench 20 during manufacture, nor welded on as with the connector ring 30 of FIGS. 1-4.

Instead, the extending adaptor interface 34 and the coupling interface 36 may be formed integrally with one another, and the ring connector 30 manufactured separately from the wrench 20 itself. After manufacturing, while in a first installation configuration the extending adaptor interface 34 of the ring connector 30 may be inserted in the adaptor channel 2. The protuberance 40 at the end of the ring connector 30 is cold-pressed, changing the ring connector 30 into a second interlocking configuration. Altering the relationship of the protuberance 40 with the adaptor channel 2 of the wrench 20, prevents inadvertent separation of the ring connector 30 from the tool 20 after assembly.

The coupling interface 34 may still be defined by a ratio of characteristics, i.e., an adaptor interface width W34 of the adaptor interface 34, which is less than an adaptor width W2 of the adaptor channel 2, i.e., W34<W2. The coupling interface 36 may also still be defined by a ratio of characteristics, i.e., the structure having an enclosed space within, defined by the coupling interface incircle 37 having an incircle diameter W37 being greater than the carabiner cross-sectional diameter W38, e.g., W37>W38. Preferably, this incircle diameter W37 is greater than 4 mm for various sized carabiners 38 having larger cross-sectional diameter W38. For this embodiment, the length of the adaptor channel L2 is determined before tooling, based upon the ratio of the connector reaching length RL30 and the body shaft length L12 of the combination tool 20.

Similar to the embodiment in FIGS. 1-4, the embodiment shown in FIGS. 5-9 still facilitates the ring connector 30 in pivoting P30 and sliding S30—without resulting in possible interference of the ring connector 30 about either working end 4, 14 of the tool 20. Unlike the embodiment in FIGS. 1-4, the embodiment shown in FIGS. 5-9, no longer facilitates rotating R30, or tilting T30.

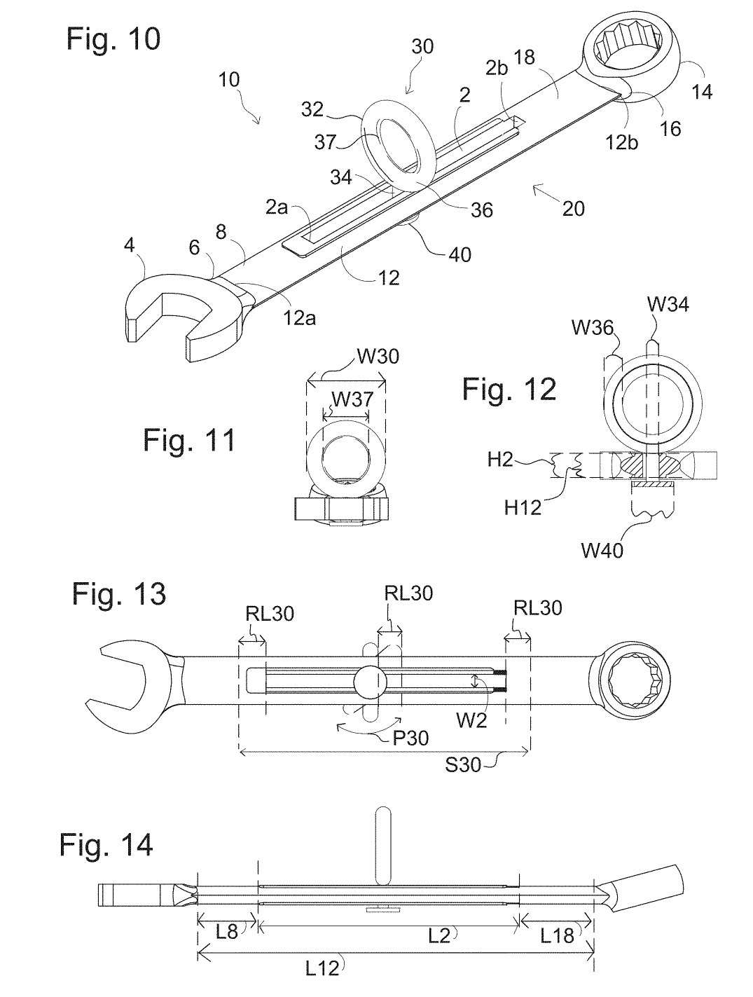

FIG. 10-14 Mushroom Connector

The combination tool attachment system 10 according to the present invention shown in FIGS. 10-14 also comprises a combination tool attachment system 10 having at least one adaptor channel 2 by which a ring connector 30 is attached along a portion of the length of the body shaft 12. As this embodiment is identical in most respects to the embodiment shown in FIGS. 5-9, only those features which are unique will now be discussed.

Similar to the embodiment shown in FIGS. 5-9, the ring connector 30 shown in the embodiment in FIGS. 10-14 has an extending adaptor interface 34 which extends outwardly from the coupling interface 36. Again, this embodiment provides additional benefits particularly associated with manufacturing. For this embodiment, the length of the adaptor channel L2 is determined before tooling, based upon the ratio of the connector reaching length RL30 and the body shaft length L12 of the combination tool 20 as before. Given a preformed dual working end combination tool 20, the adaptor channel 2 may then be formed along the body shaft 12 of the combination tool 20. The extending end 40 of the extending adaptor interface 34 is then extended through the adaptor channel 2 formed in the combination tool 20. The extending end 40 of the stem 34 opposite the coupling interface 36 may then be cold-smashed to form a protuberance 40 having a width W40 which is greater than the width W2 of the adaptor channel 2, i.e., W40>W2. As such, the headed ring connector 30 cannot be removed from the wrench, but is freely permitted to slide S30 lengthwise along the channel adaptor 2.

The adaptor interface 34 may still be defined by a ratio of characteristics, i.e., the width W34 of the adaptor interface 34 is less than an adaptor width W2 of the adaptor channel 2, i.e., W34<W2. The coupling interface 36 may also still be defined by a ratio of characteristics, i.e., the structure of the coupling interface 36 defining an incircle space 37 having an incircle diameter W37 being greater than the carabiner cross-sectional diameter W38, e.g., W37>W38 (not shown). Preferably, this incircle diameter W37 is greater than 4 mm for various sized carabiners 38 having larger cross-sectional diameters W38.

Also similar to the embodiment in FIGS. 1-9, the embodiment shown in FIGS. 10-14 still facilitates sliding S30 the ring connector 30—without resulting in possible interference of the ring connector 30 about either working end 4, 14 of the tool 20. Unlike the embodiment in FIGS. 1-4, the embodiment shown in FIGS. 10-14, no longer facilitates rotating R30, or tilting T30. However, pivoting P30 is still possible and it is to be understood that if desired, increasing the height of the adaptor interface 34 greater than the height of the wrench 20, and/or providing a hinge 35 (as shown in FIGS. 28-31) may enable tilting T30 for this embodiment.

FIG. 15-19 Transverse Dual Channel Adaptor

Similar to the embodiments shown in FIGS. 1-14, the combination tool attachment system 10 shown in FIGS. 15-19 also comprises a combination wrench 20 having at least one adaptor channel 2 by which a ring connector 30 is attached along a portion of the length of the body shaft 12. Similar to previous embodiments, the at least one adaptor channel 2 extends lengthwise along the body shaft 12. As before, the ring connector 30 has an adaptor interface 34 which interacts with the at least one adaptor channel 2. As this embodiment is identical in most respects to the embodiment shown in FIGS. 1-14, only those features which are unique to this embodiment will now be discussed.

The at least one adaptor channel 2 of the embodiment shown in FIGS. 15-19, while extending lengthwise, also extends transversely, i.e., extends along the sides of the body shaft 12 of the combination tool 20. That is, the embodiments shown in FIG. 1-14 have an adaptor channel 2 which extends from a top to a bottom of the combination tool. During use, the embodiments shown in FIG. 1-14, have torsional force applied along the sides. Contrary to this, the embodiment shown in FIGS. 15-19, has an adaptor channel 2 extending transversely along the sides, ensuring that any torsional force applied to either working end 4, 14 will be applied parallel to the sidewalls of the channel 2, thereby increasing the overall force which may be applied without threatening structural integrity. Along the same lines, the at least one adaptor channel shown here extends lengthwise only partially, width-wise, into the body shaft 12 of the combination tool 20, i.e., W2<W12. A second identical adaptor channel 2 extends transversely, and only partially, into the body shaft 12 of the combination tool 20 opposite the at least one adaptor channel 2.

The connector ring 30 shown here is capable of two configurations, a first unassembled configuration and a second assembled configuration. These configurations facilitate the connector ring 30 in releasably interlocking with the adaptor channels 2 of the combination tool 20. Once assembled, the connector ring 30 also has at least two orientations, an extended orientation, and a tilted orientation.

This releasable interlocking is enabled by having at least one adaptor interface 34 which is capable of interlocking with at least one portion of the coupling interface 36. In this embodiment, the coupling interface 36 is a partial D-ring having at least one aperture with a threaded surface. The aperture threaded surface is capable of engaging with an opposed threaded surface portion of the first adaptor interface 34, i.e., a corresponding modified screw pin. A third extruded portion abuts and separates the second threaded portion from a fourth smooth surface portion of the at least one adaptor interface 34. This smooth portion of the at least one adaptor interface 34 has a height H34 and width W34 which are less than a height H2 and width W2 of the adaptor channel 2, respectively, i.e., H34<H2 and W34<W2. This ratio ensures that once the ring connector 30 is in an interlocking configuration, the ring connector 30 is capable of sliding lengthwise S30 along the body shaft 12 of the combination tool 20.

By providing releasable interlocking components, the ring connector 30 need not be affixed to the wrench 20 during manufacture, nor welded on as with the connector ring 30 of FIGS. 1-4; nor physically altered as with the connector ring 30 of FIGS. 5-14. Instead, the combination tool 20, the at least one adaptor interface 34 having a modified screw pin, and the coupling interface having a modified torus ring, are manufactured disparately from each other, with respective tolerances.

As before, the adaptor interfaces 34 may still be defined by a ratio of characteristics, i.e., the width 34 of the adaptor interfaces 34 are less than adaptor widths W2 of the adaptor channels 2, i.e., W34<W2. The coupling interface 36 may also still be defined by a ratio of characteristics, i.e., the coupling interface 36 defining an internal space incircle 37 having an incircle diameter W37 being greater than the carabiner cross-sectional diameter W38, e.g., W37>W38. Preferably, this incircle diameter W37 is greater than 4 mm for various sized carabiners 38 having larger cross-sectional diameters W38.

As with the embodiment in FIGS. 1-4, the embodiment shown in FIGS. 15-19 still facilitates the ring connector 30 in tilting T30 and sliding S30—without resulting in possible interference of the ring connector 30 about either working end 4, 14 of the tool 20. Unlike the embodiment in FIGS. 1-4, the embodiment shown in FIGS. 15-19 no longer facilitates rotating R30 or pivoting P30. This is not to be confused with the embodiment shown in FIGS. 5-9, which facilitates pivoting P30, but no longer facilitates rotating R30, or tilting T30.

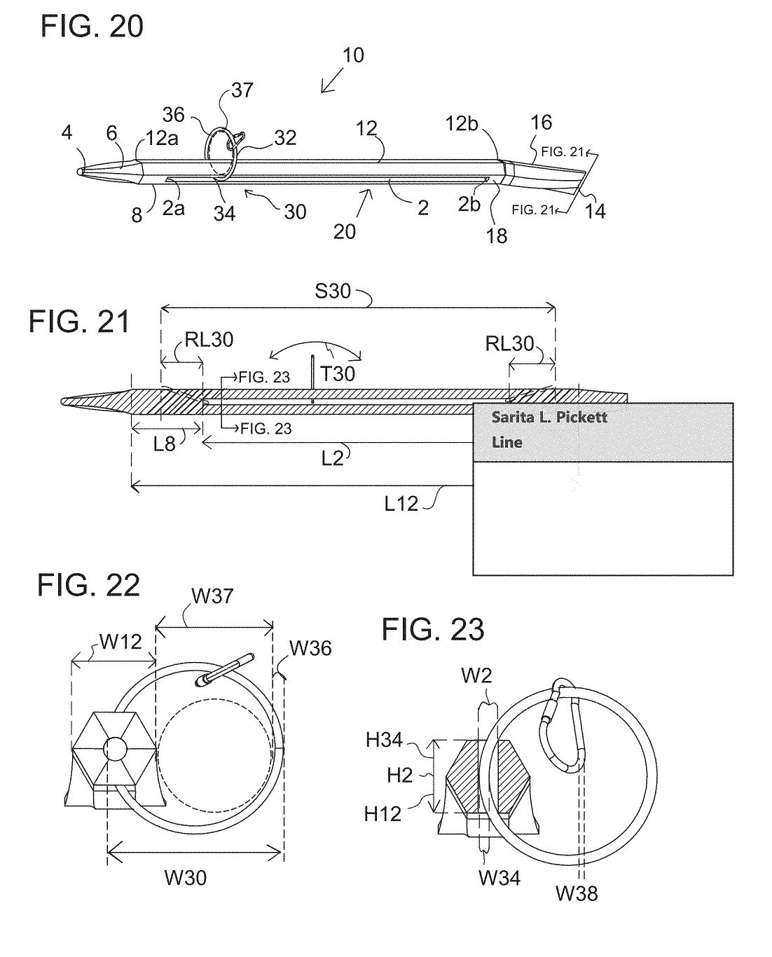

FIG. 20-43 Larger Body Shafts

The embodiments shown in FIGS. 20-43 are identical in most respects to the embodiment shown in FIGS. 1-4. Similar to the embodiments shown in FIGS. 1-4, the embodiments of the present invention shown in FIGS. 20-43 also comprise a combination tool attachment system 10 having a combination tool 20 with at least one adaptor channel 2 by which a ring connector 30 is attached along a portion of the length of the body shaft 12. Similar to previous embodiments, the at least one adaptor channel 2 extends lengthwise along the body shaft 12. As before, the ring connector 30 has an adaptor interface 34 and a coupling interface 36. The adaptor interface 34 interacts with the at least one adaptor channel 2. Despite any sliding S30, the furthest edge 32 of the ring connector 30 is always prevented from interfering with either the first or second working ends 4, 14 of the combination tool 20. Thus, whether a user grabs the body shaft 12 above or below the ring connector 30 when using either the first or the second working ends 4, 14, the first and second margin portions 8, 18 of the body shaft 12 prevent the ring connector 30 from extending to an interference position adjacent either working end 4, 14 of the tool 20.

The embodiments of the present invention shown in FIGS. 20-43 providing a combination tool 20 having a larger body shaft 12 than illustrated within FIG. 1-19, i.e., having an average body shaft length L12 in a range of about 5 inches to about 30 inches and an average body shaft height H12 in a range of about 4 mm to about 2 inches. Particularly, an aspect of the present invention illustrated within FIG. 20-43 and discussed below, in which the combination tools 20 have a body shaft 12 with an average body shaft length L12 in a range of about 18 inches to about 64 inches and an average body shaft height H12 in a range of about 1 to about 4 inches.

FIG. 20-23 Larger Coupling Interface

The system shown in FIGS. 20-23, has a combination tool which is a combination pincher bar 20 having a first working end 4 with an integral tapered portion. The first working end 4 is opposite a second working end 14 having a chisel end angled from the body shaft 12 by approximately 15 degrees.

For any embodiment in which the adaptor channel 2 is a through-channel, the channel height H2 is equal to the body shaft height H12, i.e., H2=H12. For a continuous ring connector 30, the coupling interface 36 may also be defined by a ratio of characteristics, as the coupling interface 36 at least partially defines an incircle 37 having an incircle diameter (or width) W37 greater than the carabiner cross-sectional diameter W38, e.g., W37>W38. For the continuous ring connector 30 within FIG. 20-23, this incircle diameter W37 is greater than 1 in.

The channel width W2 is less than the body shaft width W12, i.e., W2<W12. The channel length L2 is less than a body shaft length L12, i.e., L2<L12. The actual sliding length S30 of the connector ring 30 is the channel length L2 plus the reaching length RL30 at both the first channel end 2a and the second channel end 2b, i.e., S30=(L2+(RL30*2).

According to the present invention, to ensure non-interference around either working end 4, 14, both the first and the second margin portion non-interference lengths L8, L18 are greater or equal to the reaching length RL30 of the ring connector 30, i.e., RL30≤L8; RL30≤L18. The channel length L2 is equal to a body shaft length L12 plus the first and the second margin portion non-interference lengths L8, L18, e.g., L2=(L12−(L8+L18)).

Given a body shaft 12 having a specific length L12 and a ring connector 30 having a specific width W30, it is possible to determine the required channel length L2 for an adaptor channel 2. Specifically, the channel length L2 is less than or equal to a body shaft length L12 by more than twice the reaching length RL30 of the ring connector W30, i.e., L2≤(L12−(2*RL30)). Alternatively, because the reaching length RL30 of the ring connector 30 is always less than the ring connector width W30, i.e., RL30≤W30, the channel length L2 is less than or equal to a body shaft length L12 by more than twice the connector diameter W30, i.e., L2≤(L12−(2*W30)).

Thus, despite any potential moving of the ring connector 30 with respect to the body shaft 12, e.g., tilting T30, and sliding S30, the furthest edge 32 of the ring connector 30 is always prevented from interfering with either the first or second working ends 4, 14 of the combination tool 20. Thus, whether a user grabs the body shaft 12 above or below the ring connector 30 when using either the first or the second working ends 4, 14, the first and second margin portions 8, 18 of the body shaft 12 prevent the ring connector 30 from extending to an interference position adjacent either working end 4, 14 of the tool 20.

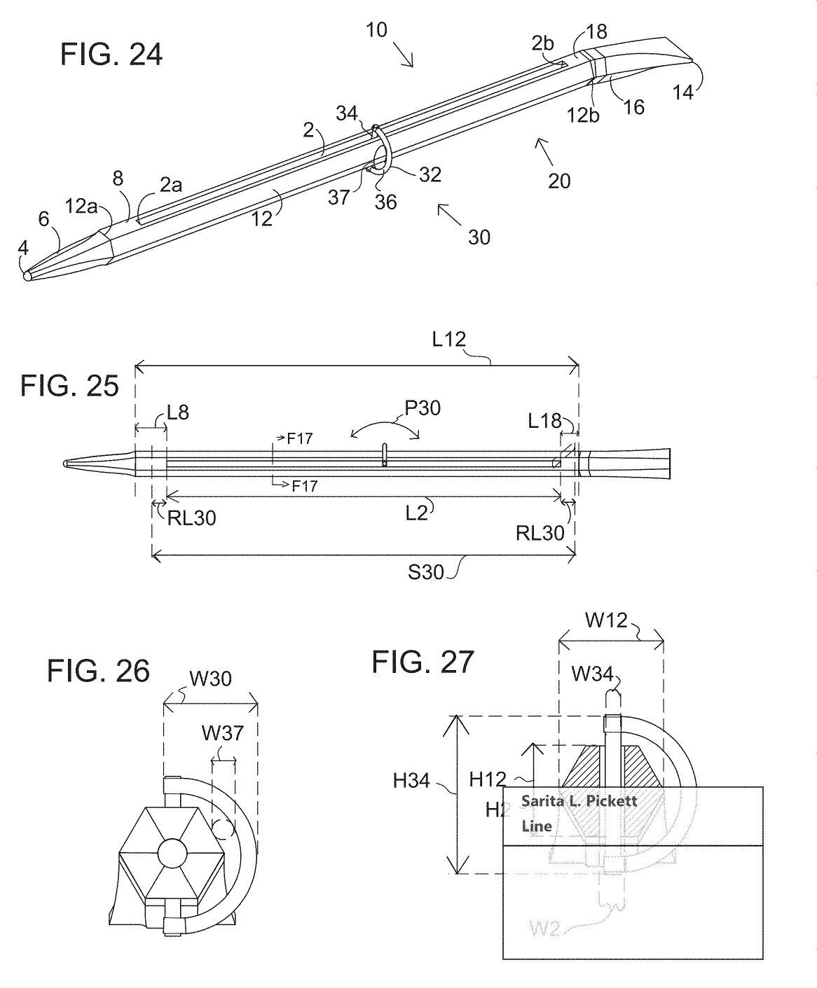

FIG. 24-27 Hollow Channel with Alternate Adaptor Interface

FIGS. 24-27 illustrate various views of an embodiment of the combination tool attachment system 10 according to the present invention a combination pincher bar 20 having an adaptor channel 2 by which a ring connector 30 is attached along a portion of the length of the body shaft 12. As this embodiment is identical in most respects to the embodiment shown in FIGS. 20-23, only those features which are unique to this embodiment will now be discussed.

Specifically, the ring connector 30 has a straight extending adaptor interface 34 which extends transversely between two opposing ends of the coupling interface 36. By extending the adaptor interface 34 straight between two ends of the coupling interface 36, the ring connector 30 illustrated in FIGS. 24-27, may have a reaching length W30 which is far smaller than a reaching length W30 of the embodiment shown in FIGS. 20-23.

In the embodiment shown here, the ring connector 30 is made from disparate components similar to the embodiment shown in FIGS. 15-19. At least one end of the adaptor interface has an interlocking component; and a corresponding interlocking feature is in the respective end of the coupling interface. Employing interlocking components, the connector may be affixed to the pincher bar 20 after manufacture. In another embodiment, the ring connector 30 is welded on and made integral, i.e., in a single piece. Similarly, the ring connectors 30 shown in FIGS. 5-19 may also be employed with a combination pincher bar 20 having an adaptor channel 2 extending through the body shaft 12 as shown in FIGS. 4-27.

FIG. 28-31 Branching Adaptor Channel W/Folding Connector

The combination tool attachment system 10 according to the present invention shown next in FIGS. 28-31 illustrate various views of a combination pincher bar 20 having an adaptor channel 2 by which a ring connector 30 is attached along a portion of the length of the body shaft 12. As this embodiment is identical in most respects to the embodiment shown in FIGS. 20-23, only those features which are unique to this embodiment will now be discussed.

Specifically, the ring connector 30 has a hinge 35, between the adaptor interface 34 and the coupling interface 36, enabling the ring connector 30 to shift between first extended and second folded configurations. In the second folded configuration, the coupling interface 36 extends parallel to the nearest face of the combination bar 20. Thus, when the coupling interface 36 is no longer attached to a carabiner or safety line, likelihood of damage to the ring connector 30 is reduced.

Similar to the extending adaptor interface of FIG. 5-14, the coupling interface 36 is a solid torus ring connected to one end of the adaptor interface 34. At an opposite end of the adaptor interface 34, a protuberance 40 has a width 40W that is greater than the width 2W of the adaptor channel 2, thereby preventing inadvertent separation of the ring connector 30 from the tool 20 after assembly, i.e., W40>W2. Contrary to the adaptor interface 34 of FIG. 5-14, in FIG. 28-31 the ring connector 30 has an adaptor interface 34 with a shorter overall height, i.e., H34<H2.

The coupling interface 36 may also still be defined by a ratio of characteristics, as the coupling interface 36 at least partially defines an incircle 37 having an incircle diameter (or width) W37 greater than the carabiner cross-sectional diameter W38, e.g., W37>W38. Preferably, this incircle diameter W37 is greater than 2 mm for various sized carabiners 38 having larger cross-sectional diameters W38.

The embodiment shown in FIGS. 28-31 has a width W34 of the adaptor interface 34 which is less than an adaptor width W2 of the adaptor channel 2, i.e., W34<W2. This relationship between the adaptor interface width W34 and the adaptor width W2 facilitates the ring connector 30 in sliding S30 along the length L2 of the channel.

Corresponding to the adaptor interface 34, the adaptor channel 2 is also branched to accommodate the protuberance 40, where the branches have a width that is greater than the width of the protuberance so as to facilitate sliding S30 along the adaptor channel 2. The adaptor channel 2 has a shorter overall height, which may also be defined by a ratio of characteristics, i.e., H2≠H2 and H2<H12.

Installation of the connector ring 30 is facilitated by initially extending the adaptor channel beyond the second margin portion length L18 into the second neck portion 16 of the second working end 14. Note that the due to the inclined slope of the second neck portion 16, the internal surfaces of the adaptor channel 2 eventually plateau with the external surface(s) along the second neck portion 16. After installing the connector ring 30, an adaptor seal 81 fills a portion of the adaptor channel 2 nearest the second working end 14 forming the second margin portion 18.

The adaptor seal 81 may be any combination of spring pin, dowel, mushroom cap, rivet, a nitrogen chilled dowel pin, spot weld seal, and/or similar seal, so long as it is capable of permanently fastening to the internal surfaces of the adaptor channel and securing the connector ring 30. For example, in FIG. 28-31, the adaptor seal 81 has two components, a horizontal seal component extending within and parallel along the adaptor channel, and a vertical seal component extending through and perpendicular to the adaptor channel and horizontal seal component.

The seal length L81 is greater than the second margin portion L18, i.e., L81>L18. The relationship between the first and second margin portion lengths L8, L18 and reaching length RL30 of the connector ring 30, i.e., RL30≤L8, RL30≤L18, prevents any possible interference of the ring connector 30 about either working end 4, 14 of the tool 20.

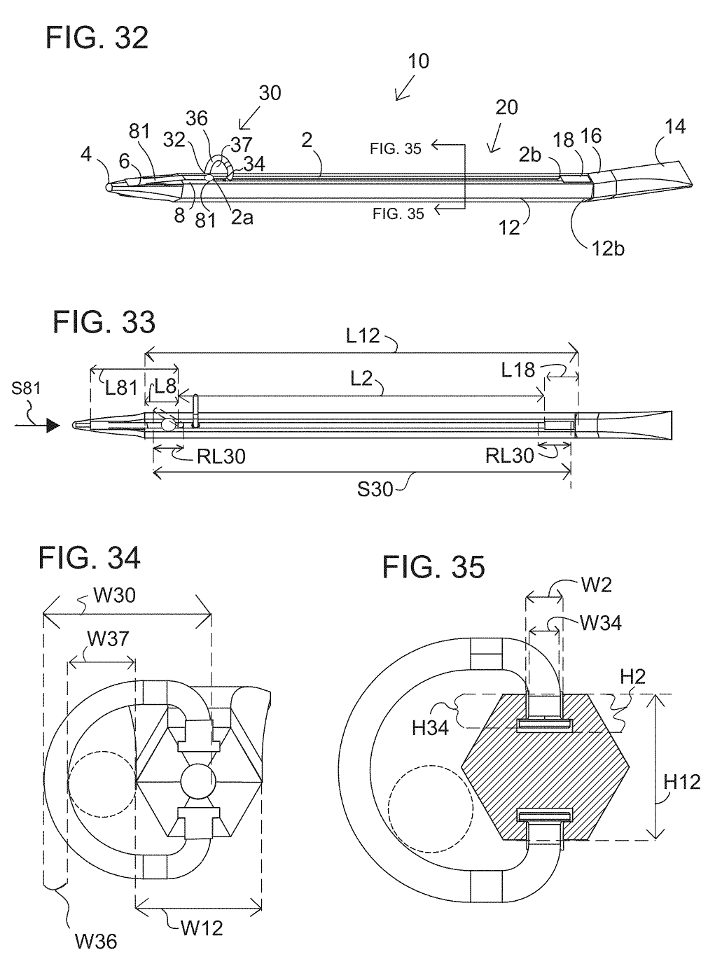

FIG. 32-35 Dual Interior Branching Adaptor Channel

The combination tool attachment system 10 according to the present invention shown in FIGS. 32-35 also comprises a combination tool attachment system 10 having at least one adaptor channel 2 by which a ring connector 30 is attached along a portion of the length of the body shaft 12. As this embodiment is identical in most respects to the embodiment shown in FIGS. 20-23, only those features which are unique will now be discussed.

The at least one adaptor channel 2 of the embodiment shown in FIGS. 32-35, is a branching adaptor channel extending lengthwise along, and only partially into, the body shaft 12 of the combination tool 20, i.e., H2<H12. An identical second adaptor channel 2 extends lengthwise along, and only partially into, the body shaft 12 of the combination tool 20 opposite the at least one adaptor channel 2, i.e., H2<H12.

Dual adaptor interfaces 34 extend from opposite ends of the coupling interface 36. However, the adaptor interfaces shown here lack a branched protuberance 40, instead a single protruding end 40 enables two configurations. The first configuration enables the connector ring to be installed on a first side of the combination tool, whereas the second configuration enables the connector ring to be installed on a second side of the combination tool 20. Regardless, each branch of the adaptor channel 2 is sized to accommodate the protuberance 40, where the branches have a width that is greater than the width of the protuberance so as to facilitate sliding 330 along the adaptor channel 2.

The coupling interface 36 may also still be defined by a ratio of characteristics, as the space defined at least partially by the coupling interface 36 has an incircle diameter (or width) W37 greater than the carabiner cross-sectional diameter W38, e.g., W37>W38. Preferably, this incircle diameter W37 is greater than 2 mm for various sized carabiners 38 having larger cross-sectional diameters W38.

The embodiment shown in FIGS. 32-35 has an adaptor interface width W34 of the ring connector 30 which is less than an adaptor channel width W2 of the adaptor channel 2, i.e., W34<W2. This relationship between the adaptor interface width W34 and the adaptor width W2 facilitates the ring connector 30 in freely sliding S30 along the length L2 of the channel 2.

Installation of the connector ring 30 is facilitated by initially extending the adaptor channel beyond the first margin portion length L8 into the first neck portion 6 of the first working end 4. Note that the due to the inclined slope of the first neck portion 6, the internal surfaces of the adaptor channel 2 eventually plateau with the external surface(s) along the first neck portion 6. After installing the connector ring 30, an adaptor seal 81 fills a portion of the adaptor channel 2 nearest the first working end 4 forming the first margin portion 8. The seal length L81 is greater than the first margin portion L8, i.e., L81>L8. After installation of the seal 81, the channel length L2 is less than the main body length L12, i.e., L2<L12. The relationship between the first and second margin portion lengths L8, L18 and reaching length RL30 of the connector ring 30, i.e., RL30≤L8, RL30≤L18, prevents any possible interference of the ring connector 30 about either working end 4, 14 of the tool 20.

As with the embodiment in FIGS. 1-4, the embodiment shown in FIGS. 32-35 still facilitates the ring connector 30 in pivoting P30 and sliding S30—without resulting in possible interference of the ring connector 30 about either working end 4, 14 of the tool 20. Unlike the embodiment in FIGS. 1-4, the embodiment shown in FIGS. 32-35 no longer facilitates rotating R30 or tilting T30.

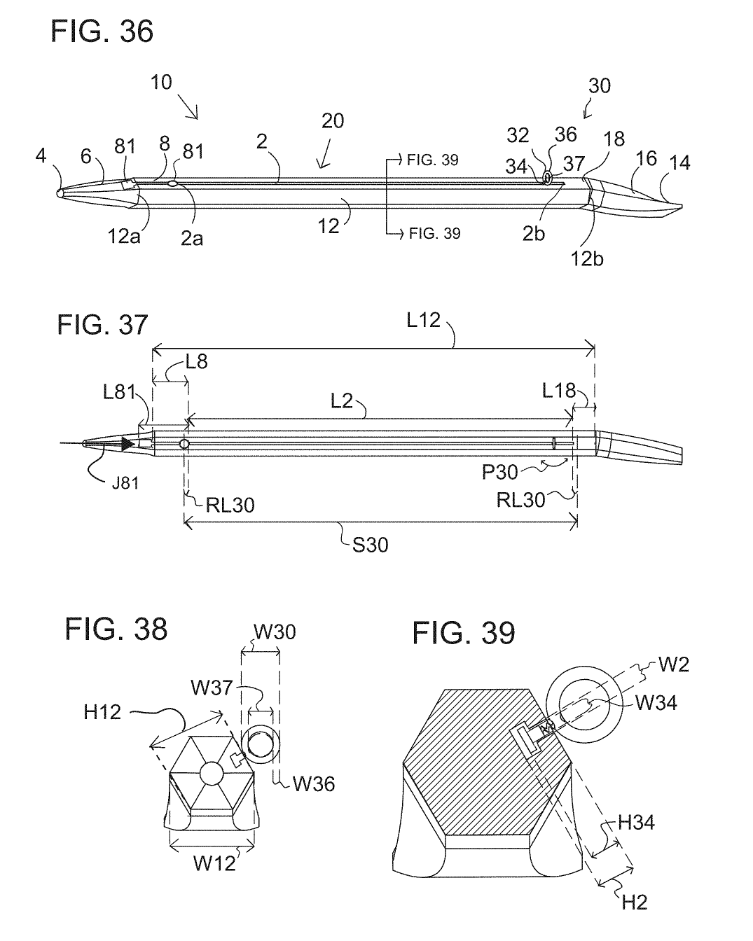

FIG. 36-39 Transverse Adaptor Channel

Similar to the embodiments shown in FIGS. 20-24, the combination tool attachment system 10 shown in FIGS. 35-39 also comprises a combination pincher bar 20 having at least one adaptor channel 2 by which a ring connector 30 is attached along a portion of the length of the body shaft 12. Similar to previous embodiments, the at least one adaptor channel 2 extends lengthwise along the body shaft. As before, the ring connector 30 has an adaptor interface 34 which interacts with the at least one adaptor channel 2. As this embodiment is identical in most respects to the embodiments shown previously, only those features which are unique to this embodiment will now be discussed.

The adaptor channel 2 of the embodiment shown in FIGS. 36-39, while extending lengthwise, also extends transversely, i.e., extends along the sides of the body shaft 12 of the combination tool 20. That is, the embodiment shown in FIG. 20-23 has an adaptor channel 2 which extends from a top to a bottom of the body shaft 12 of the combination tool 20. During use, the embodiments shown in FIG. 1-14, have torsional force applied along the sides. Contrary to this, the embodiment shown in FIGS. 36-39, has an adaptor channel 2 extending transversely along a side of the body shaft 12. Thereby increasing the overall force which may be applied to either working end 4, 14 without threatening the structural integrity of the body shaft 12 regardless of any torsional force applied. Along the same lines, the at least one adaptor channel shown here extends lengthwise only partially into the body shaft 12 of the combination tool 20. Thus, the transverse height H12 of the body shaft 12 is greater than the transverse height H2 of the adaptor channel, i.e., H2<H12.

Installation of the connector ring 30 is facilitated by initially extending the adaptor channel lengthwise beyond the first margin portion length L8 into the first neck portion 6 of the first working end 4. Note that the due to the inclined slope of the first neck portion 6, the internal surfaces of the adaptor channel 2 eventually plateau with the external surface(s) along the first neck portion 6. After installing the connector ring 30, an adaptor seal 81 is installed via welding, or being inserted for example, in the joining direction J81. The adaptor seal 81 fills a lengthwise portion of the adaptor channel 2 nearest the first working end 4 forming the first margin portion 8. The seal length L81 is greater than the first margin portion L8, i.e., L81>L8. After installation of the seal 81, the channel length L2 is less than the main body length L12, i.e., L2<L12. The first and second margin portion lengths L8, L18 prevents any possible interference of the ring connector 30 about either working end 4, 14 of the tool 20.

The connector ring 30 shown here is capable of two configurations, a first unassembled configuration and a second assembled configuration. These configurations facilitate the connector ring 30 in releasably interlocking with the adaptor channel 2 of the combination tool 20. This releasable interlocking is enabled by having at least a portion of an adaptor interface 34 which is capable of interlocking with at least one portion of the coupling interface 36.

In this embodiment, the coupling interface 36 is a modified D-ring having at least one aperture with a threaded surface. The aperture threaded surface is capable of engaging with an opposed threaded surface portion of the adaptor interface 34, i.e., a corresponding modified screw pin. By providing releasable interlocking components, the ring connector 30 need not be affixed to the wrench 20 during manufacture, nor welded on as with the connector ring 30 of FIGS. 1-4; nor physically altered as with the connector ring 30 of FIGS. 5-14. Instead, the combination tool 20, the adaptor interface 34, and the coupling interface are manufactured disparately from each other, with respective tolerances.

Once the ring connector 30 is in an interlocking configuration, a ratio of sizes ensures that the ring connector 30 is capable of sliding lengthwise S30 along the body shaft 12 of the combination tool 20. Specifically, a smooth portion of the at least one adaptor interface 34 has a height H34 and width W34 which are less than a height H2 and width W2 of the adaptor channel 2, respectively, i.e., H34<H2 and W34<W2. An end protuberance 40 has a width W40 greater than the width W2 of the adaptor channel 2 thereby preventing inadvertent disconnection thereof.

As with the embodiment in FIGS. 20-23, the embodiment shown in FIGS. 36-39 still facilitates the ring connector 30 in sliding S30—without resulting in possible interference of the ring connector 30 about either working end 4, 14 of the tool 20. Unlike the embodiment in FIGS. 1-4, the embodiment shown in FIGS. 36-39 no longer facilitates tilting, rotating R30, and/or pivoting P30.

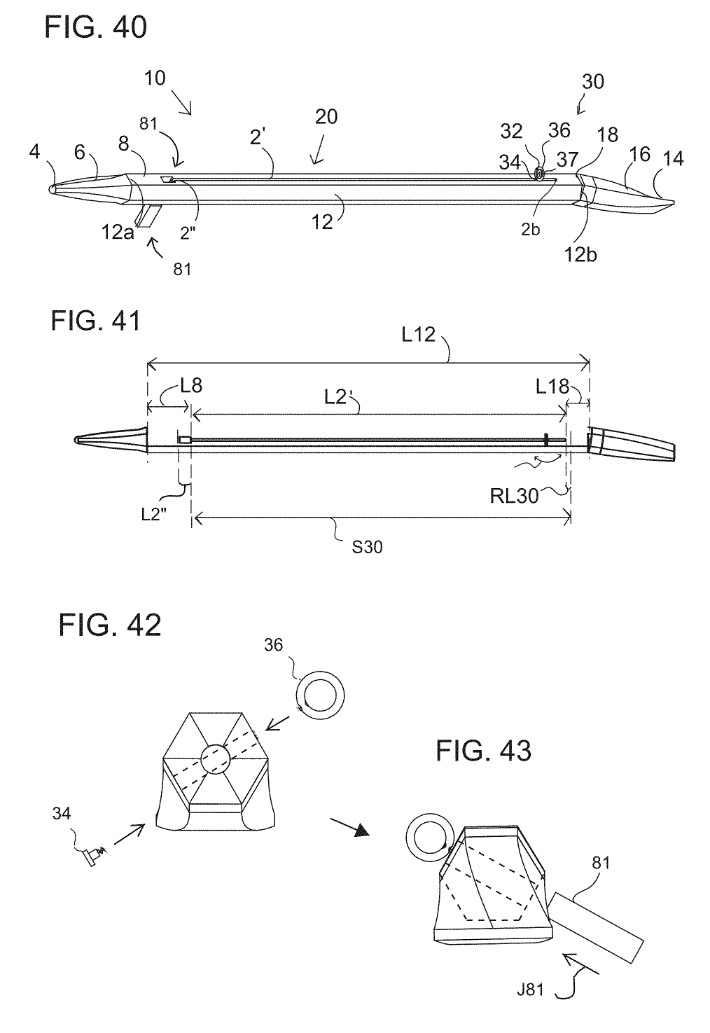

FIG. 40-43 Transverse Partial Adaptor Channel Having Through Portion

Similar to the embodiments shown in FIGS. 36-39, the combination tool attachment system 10 shown in FIGS. 40-43 also comprises a combination pincher bar 20 having at least one adaptor channel 2 by which a ring connector 30 is attached along a portion of the length of the body shaft 12. Similar to previous embodiments, the at least one adaptor channel 2 extends lengthwise along the body shaft. As before, the ring connector 30 has an adaptor interface 34 which interacts with the at least one adaptor channel 2. More particularly, the embodiment of the present invention shown in FIGS. 40-43 has a combination tool attachment system 10 which is very similar to the embodiment of the present invention shown in FIGS. 36-39. As this embodiment is identical in most respects to the embodiments shown previously, only those features which are unique to this embodiment will now be discussed.

As before, the adaptor channel 2 of the embodiment shown in FIGS. 40-43, while extending lengthwise, also extends transversely, i.e., extends along the sides of the body shaft 12 of the combination tool 20. Similar to the embodiment of the present invention shown in FIGS. 36-39, the at least one adaptor channel 2 extends transversely lengthwise into the body shaft 12 of the combination tool 20. Contrary to the embodiment of the present invention shown in FIGS. 36-39, the adaptor channel 2 of the embodiment shown in FIGS. 40-43 does not continue lengthwise beyond the body shaft. Instead, the adaptor channel has first and second adaptor channel portions 2′, 2″ which extend for different lengths L2′ and L2″ and different heights H2′, H2″ (not shown).

As shown in FIG. 42, installation of the connector ring 30 is facilitated by initially extending the second adaptor channel portion 2″ (in dotted lines) for a transverse height H2″ through the transverse height H12 of the body shaft 12, i.e., H2′″?H12. Thus the adaptor interface 34 and the connector interface 36, are joined together through (and on opposite sides of) this lengthwise adaptor channel portion 2″. After installing the connector ring 30, by connecting the interlocking components of the adaptor interface 34 and the connector interface 36, an adaptor seal 81 is installed via welding, or being inserted for example, in the joining direction J81.

It is to be understood that, although not shown, ring connectors 30 of any of the above embodiments may be made from disparate components, similar to the embodiments shown in FIGS. 15-19 and FIGS. 24-43, where the adaptor interface and the coupling interface have an interlocking component; and a corresponding interlocking feature. Similarly, the ring connector 30 shown in any of FIGS. 1-43 may be employed with any other adaptor channel, so long as the appropriate height and width ratios are maintained to ensure secure installation.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A combination tool attachment system comprising:
a combination tool comprising:
a first working end having a first neck portion;
a second working end having a second neck portion;
a body shaft extending between the first working end and the second working end, the body shaft having first and second margin portions adjacent the first working end and the second working end, respectively, and a middle portion extending between the first and second margin portions; and
at least one elongated adaptor channel formed along the middle portion of the body shaft, the at least one elongated adaptor channel having first and second channel ends adjacent first and second margin portions, respectively;
a ring connector comprising:
at least one adaptor interface slidably disposed within the at least one adaptor channel; and
a coupling interface attached to the at least one adaptor interface, the coupling interface forming an enclosed space either independently or with the body shaft, the enclosed space defining an incircle with a diameter of a size sufficient to interconnect with a lanyard fastener; and
wherein the first and second margin portions prevent the ring connector from interfering with either the first or second working ends despite any rotating, pivoting, tilting, and sliding of the ring connector with respect to the body shaft.

2. The combination tool attachment system of claim 1, wherein the first and second margin portions have first and second lengths, respectively, and each is greater than a reaching length of the ring connector.

3. The combination tool attachment system of claim 1, wherein the combination tool is one of a combination wrench and a combination pincher bar.

4. The combination tool attachment system of claim 1, wherein the adaptor channel has: an adaptor channel height which is equal to a body shaft height; an adaptor channel length which is less than a body shaft length; and an adaptor channel width which is less than a body shaft width, wherein the adaptor channel width is greater than an adaptor interface width of the at least one adaptor interface.

5. The combination tool attachment system of claim 1, wherein the ring connector is a solid torus ring; the diameter of the incircle is less than a diameter of the solid torus ring; and the lanyard fastener is a carabiner having a cross-sectional diameter less than the diameter of the incircle.

6. The combination tool attachment system of claim 1, wherein
the coupling interface of the ring connector is a solid torus ring, such that the incircle diameter is equal to an internal diameter thereof; and
the at least one adaptor interface extends from a first end to a second end, the first end being connected to the coupling interface, and the second end being a protuberance having a width greater than a width of the at least one elongated adaptor channel.

7. The combination tool attachment system of claim 1, wherein
the adaptor interface and the coupling interface of the ring connector are distinct, separable, physical components from one another;
the adaptor interface has a first interlocking portion; and
the coupling interface has a second interlocking portion which corresponds to the first interlocking portion of the adaptor interface, whereby the adaptor interface and the coupling interface being releasably interlocking with one another.

8. The combination tool attachment system of claim 1, wherein
the adaptor channel and adaptor interface are sized with respect to one another with a ratio relating the cross-sectional diameter and the adaptor width, and the ratio facilitates rotating, pivoting, tilting, and sliding of the ring connector with respect to the body shaft.

9. The combination tool attachment system of claim 1, wherein
the adaptor channel has an adaptor channel height which is equal to a body shaft height, an adaptor channel length which is less than a body shaft length, and an adaptor channel width which is less than a body shaft width and greater than an adaptor interface width.

10. The combination tool attachment system of claim 1, wherein
the first and second margin portions have incongruent first and second lengths, and the first and second lengths are both greater than a reaching length of the ring connector.

11. The combination tool attachment system of claim 1 wherein the adaptor channel has a height equal to a height of the body shaft of the combination tool.

12. The combination tool attachment system of claim 1 wherein the adaptor channel has a height less than a height of the body shaft of the combination tool.

13. The combination tool attachment system of claim 1 wherein the at least one adaptor channel has a height less than a height of the body shaft of the combination tool; and is a branching adaptor channel having at least one interior channel branch extending lengthwise along the body shaft of the combination tool.

14. A combination tool attachment system comprising:
a combination tool having:
opposed first and second working ends having opposed first and second neck portions, respectively;
a body shaft extending between the first and second neck portions, the body shaft having first and second margin portions and a middle portion therebetween, the first and second margin portions adjacent the first and second neck portions, respectively; and
at least one adaptor channel extending lengthwise along the body shaft between the first and second margin portions; and
a ring connector having:
an adaptor interface interacting with the at least one adaptor channel; and
a coupling interface at least partially defining an include with a diameter of a size sufficient to interconnect with a lanyard fastener;
wherein first and second margin portion lengths of the body shaft are both greater than a reaching length of the ring connector.

15. A combination tool attachment system comprising:
a combination tool comprising:
a body shaft having: a first margin portion formed adjacent a first end of the body shaft, a second margin portion formed on adjacent an opposite second end of the body shaft, and a middle portion formed between the first margin portion and the second margin portion;
at least one elongated adaptor channel being formed along the middle portion of the body shaft, between the first margin portion and the second margin portion, the at least one elongated adaptor channel having: a first channel end adjacent the first margin portion, and a second channel end adjacent the second margin portion;
a first working end having a first neck portion, the first neck portion connecting the first working end to the first margin portion of the body shaft, and a distance between the first neck portion and the first channel end defines a first margin portion length associated with the first margin portion of the body shaft; and
a second working end having a second neck portion, the second neck portion connecting the second working end to the second margin portion of the body shaft, the second working end being opposite the first working end, and a distance between the second neck portion and the second channel end defines a second margin portion length, associated with the second margin portion of the body shaft; and
a ring connector comprising:
at least one adaptor interface corresponding to the at least one adaptor channel, the at least one adaptor interface being slidably disposed within the at least one adaptor channel; and
a coupling interface attached to the adaptor interface, a surface of the coupling interface at least partially defines an incircle of an enclosed space, wherein the enclosed space is bounded by one of surfaces of the coupling interface with surfaces of the adaptor interface, surfaces of the coupling interface with surfaces of the body shaft, and only surfaces of the coupling interface, and wherein the enclosed space is unencumbered by the body shaft and displaced from the combination tool.
